(19) United States
(12) Patent Application Publication
(10) Pub. No.: US 2023/0193737 A1
(43) Pub. Date: Jun. 22, 2023

(54) SUBSEA PHASE-SEPARATION AND DENSE GAS REINJECTION BY USING A PUMP

(71) Applicant: Vetco Gray Scandinavia AS, Stavanger (NO)

(72) Inventors: Romulo Almeida, Rio de Janeiro (BR); Rafael Horschutz Nemoto, Rio de Janeiro (BR); Gerardo Sanchez Soto, Rio de Janeiro (BR); Julia Renha, Rio de Janeiro (BR); Fernanda Pedo, Rio de Janeiro (BR); Thiago Salcedo, Rio de Janeiro (BR)

(21) Appl. No.: 17/995,960

(22) PCT Filed: Apr. 13, 2021
(86) PCT No.: PCT/EP2021/025135

§ 371 Date: Oct. 11, 2022

(30) Foreign Application Priority Data
Apr. 15, 2020 (NO) 20200458

(51) Int. Cl. E21B 43/36; B01D 17/02; E21B 43/01; E21B 43/40

(52) U.S. Cl. CPC E21B 43/36; B01D 17/02; E21B 43/01; E21B 43/40

(57) ABSTRACT

The present invention discloses a scalable modular fluid separation system at least comprising: a) a subsea separator with an inlet for receiving well fluids from a separator inlet stream; b) a gas stream piping from a gas stream outlet of the subsea separator; c) a booster pump in communication with the gas stream outlet of the subsea separator; d) a liquid stream piping from a liquid stream outlet of the subsea separator; and e) a liquid pressure booster in communication with the liquid stream outlet of the subsea separator.

### TECHNICAL FIELD

The present invention relates to a subsea system for phases separation, [symbol] in particular the present invention relates to scalable modular fluid separat [symbol] system.

### BACKGROUND ART

With increasingly environmental restrictions, venting greenhouse gases to atmosphere is not an option.

Offshore petroleum production demands, generally, a platform or FPSO (floating, production, storage and offloading vessel) for receiving the produced fluids. Associated with the oil production, we may have gas and water production. Water must be treated and either reinjected into the reservoir or disposed in the ocean. Gas can be exported to land by means dedicated pipelines or be flared. In some cases, gas may contain elevate [symbol] content of undesirable components, such as H₂S and CO₂. In this case, d [symbol] to increasingly environmental restrictions, gas must either be treated accordingly and flared or simply be reinjected into the reservoir.

Such gas and water treatment demand increased topside (i.e., in platform footprint dedicated to processing systems. Consequently, a platform/FPSO( [symbol] greater dimension and complexity is made necessary. An alternative to topside processing is subsea processing, which allows reduction in processing equipment footprint located topside, as well as elimination of eventual processing bottlenecks.

Offshore petroleum production fields produce hydrocarbons and water in different quantities over the years. Generally, in early production stage (greenfield), mainly hydrocarbons (in the form of oil and gas) are produce [symbol] After some time of production, some reservoirs begin to produce water. T [symbol] water production can increase dramatically, so that, in the late production stage (brownfield), higher water contents may result in an economically unfeasible field production.

Additionally, some reservoirs may provide a fluid composition that is richer in lighter hydrocarbons and CO₂ (carbon dioxide), for instance, generating huge volumes of gas as pressure drops along the fluid transportation system (flowlines, risers. valves, etc). Generally, as water production increases, we may expect less gas to be produced.

Consequently, subsea separation and reinjection systems need to be flexible to cope with different production scenarios that a given field may experience during its production lifetime.

### DISCLOSURE OF INVENTION

The current invention presents a method for allowing phase-separation and reinjection taking into consideration such different production scenarios over years by means of an adaptable and time-evolving subsea processing system.

Production of petroleum reservoirs that provide fluids with high content of CO₂ would benefit of the proposed invention. By allowing part of the associated CO2 to be separated and reinjected into the reservoir at subsea level, volumes of CO₂ that reaches topside platform can be reduced. Similarly, water may also be separated and reinjected subsea. This procedure would eliminate the need of large processing capacities to be installed topside in the FPSO/platform. Consequently, conventional smaller vessels could be utilised for producing such fields.

It is one object of the invention to provide a complete modular subsea system capable to separate oil plus produced water from CO₂ gas and to separate oil from the produced water in a second stage, in aim to send the oil only to an oil receiving facility and reinject compressed CO₂ gas and produced water into the reservoir, normally aided a pressure booster.

The modular system according to the present invention provides reinjection of CO₂ gas and produced water. This ensures that the same level of reservoir pressure along of the field production life will be maintained in aim to stay close to the maximum reliable oil recuperation from a reservoir.

According to the invention it is disclosed a scalable modular fluid separation system at least comprising:

a subsea separator with an inlet for receiving well fluids from a separator inlet stream;
a gas stream piping from a gas stream outlet of the subsea separator;
a booster pump in communication with the gas stream outlet of the subsea separator;
a liquid stream piping from a liquid stream outlet of the subsea separator;
a liquid pressure booster in communication with the liquid stream outlet of the subsea separator.

The gas stream can be directed from the subsea separator to the booster pump where the gas stream pressure is boosted by the booster pump and directed to a reinjection well, and the liquid stream is directed from the subsea separator to the liquid pressure booster where the liquid stream pressure is boosted by the liquid pressure booster and the liquid is directed to one of a liquid receiving facility, an oil receiving facility and a reinjection well.

The scalable modular fluid separation system may further comprise a heat exchanger in communication with the gas stream piping from the subsea separator wherein the gas stream is directed from the subsea separator, to the booster pump where the gas stream pressure is boosted by the booster pump and directed to a reinjection well.

In one aspect of the invention the booster pump can be a dense gas pump.

The scalable modular fluid separation system may additionally comprise an inlet manifold, where the inlet manifold is in communication with the inlet for receiving well fluids from a separator inlet stream.

In one aspect of the invention the subsea separator is a subsea 2-phase gas to liquid separator, and in another aspect the subsea separator is a subsea 3-phase gas-oil-water separator where the 3-phase gas-oil-water separator further includes a water stream outlet and an oil stream outlet.

The water stream from the subsea 3-phase gas-oil-water separator can be directed to a water pump where the water stream is boosted by the water pump and the water is directed to a reinjection well, and the oil stream is directed from the subsea 3-phase gas-oil-water separator to an oil pump where the oil stream is boosted by the oil pump and the oil is directed to an oil receiving facility.

In the 2-phase system the liquid stream can be directed from the liquid stream outlet of the subsea 2-phase gas-liquid separator to an inlet of a 2-phase oil water separator to provide a two stage gas-oil-water separation station where the liquid is separated into:

a water stream and where the water stream can be directed to a water pump where the water stream is boosted by the water pump and the water is directed to a reinjection well, and an oil stream and where the oil stream can be directed to an oil pump where the oil stream is boosted by the oil pump and the oil is directed to an oil receiving facility.

A 2-phase fluid separation system as described above can be upscaled to comprise:

several 2-phase subsea separators each with an inlet for receiving well fluids from an associated well;
a gas stream piping from a gas stream outlet of each of the 2-phase subsea separators;
a gas reinjection module in communication with the gas stream outlet of the several 2-phase subsea separators;
a liquid stream piping from a liquid stream outlet of each of the 2-phase subsea separator;
a liquid pumping module in communication with the liquid stream outlet of the several 2-phase subsea separators,
wherein the gas streams are directed from each of the 2-phase subsea separators to a gas reinjection module inlet where each of the gas streams are directed to a booster pump and directed to a reinjection well,
and each of the liquid streams can be directed from each of the 2-phase subsea separators to a liquid pumping module inlet where each of the liquid streams can be directed to a liquid pressure booster and the liquid cab be directed to one of a liquid receiving facility, an oil receiving facility and a reinjection well.

The gas reinjection module inlet can be an inlet manifold, and where the liquid pumping module inlet can be an inlet manifold.

The gas reinjection module may further comprise heat exchangers.

A 3-phase fluid separation system as described above can be upscaled to comprise:

several 3-phase subsea separators each with an inlet for receiving well fluids from an associated well;
a gas stream piping from a gas stream outlet of each of the 3-phase subsea separators;
a gas reinjection module in communication with the gas stream outlet of the several 3-phase subsea separators;
a water stream piping from a water stream outlet of each of the 3-phase subsea separators;
a water reinjecting module in communication with the water stream outlet of the several 3-phase subsea separators;
an oil stream piping from a water stream outlet of each of the 3-phase subsea separators;
an oil pumping module in communication with the oil stream outlet of the several 3-phase subsea separators,
wherein the gas streams can be directed from each of the 3-phase subsea separators to a gas reinjection module inlet where each of the gas streams can be directed to a booster pump and directed to a reinjection well,
and each of the water streams can be are directed from each of the 3-phase subsea separators to a water pumping module inlet where each of the water streams are directed to a water pressure booster and the water is directed to a reinjection well, and
each of the oil streams can be directed from each of the 3-phase subsea separators to an oil pumping module inlet where each of the oil streams can be directed to an oil pressure booster and the oil is directed to an oil receiving facility.

The gas reinjection module inlet can be an inlet manifold, the water pumping module inlet can be an inlet manifold, and where the oil pumping module inlet can be an inlet manifold.

The gas reinjection module may further comprise heat exchangers.

In one aspect of the invention the scalable modular fluid separation system may further comprise:

several two stage gas-oil-water separation stations each with an inlet for receiving well fluids from an associated well;
a gas stream piping from a gas stream outlet of each of the two stage gas-oil-water separation stations;
a gas reinjection module in communication with the gas stream outlet of the several two stage gas-oil-water separation stations;
a water stream piping from a water stream outlet of each of the two stage gas-oil-water separation stations;
a water reinjecting module in communication with the water stream outlet of the several two stage gas-oil-water separation stations;
an oil stream piping from a water stream outlet from each of the two stage gas-oil-water separation stations;
an oil pumping module in communication with the oil stream outlet of the several two stage gas-oil-water separation stations,
wherein the gas streams can be directed from each of the two stage gas-oil-water separation stations to a gas reinjection module inlet where each of the gas streams can be directed to a booster pump and directed to a reinjection well,
and each of the water streams can be directed from each of the two stage gas-oil-water separation stations to a water pumping module inlet where each of the water streams can be directed to a water pressure booster and the water is directed to a reinjection well, and
each of the oil streams can be directed from each of the two stage gas-oil-water separation stations to an oil pumping module inlet where each of the oil streams are directed to an oil pressure booster and the oil is directed to an oil receiving facility. The gas reinjection module may further comprise heat exchangers.

### BRIEF DESCRIPTION OF DRAWINGS

Following is a brief description of the drawings in order to make the invention more readily understandable, the discussion that follows will refer to the accompanying drawings, in which

FIG. 1 Shows a basic embodiment of the present invention, including subsea 2-phase gas-liquid separator and directing gas to reinjection well;

FIG. 2. Shows a single separation stage similar to that of FIG. 1, with additional heat exchanger and the gas compressor of FIG. 1 is replaced by a dense gas pump;

FIG. 3. Shows a subsea system for separation of gas-water and oil from well fluids with a single 3-phase separator;

FIG. 4 Shows a subsea system for separation of gas-water and oil from well fluids with a two stage 3-phase separator;

FIG. 5. Shows a scaled up version of the system showed in FIG. 2 including several separation modules, a reinjection module and a liquid pumping module;

FIG. 6. Shows a scaled up version of the system showed in FIG. 3 including several 3-phase separation modules, a gas reinjection module, a water reinjection module and an oil pumping module;

FIG. 7 Show a scaled up version of the system showed in FIG. 4 including several 3-phase two stage separation modules, a gas reinjection module, a water reinjection module and an oil pumping module;

### DETAILED DESCRIPTION OF THE INVENTION

In the following it is firstly disclosed general embodiments in accordance to the present invention, thereafter particular exemplary embodiments will be described. Where possible reference will be made to the accompanying drawings and where possible using reference numerals in the drawings. It shall be noted however that the drawings are exemplary embodiments only and other features and embodiments may well be within the scope of the invention as described.

The present invention discloses scalable and modular phase separation systems for subsea use. The system is characterised by a scalability flexibility, the scalability is a to an extent the consequence of the modularity of the present invention, consequently, components of systems according to the present invention can easily be combined to achieve intended characteristics and functions.

A subsea separation system in accordance with the present invention may comprise several modules such as:
Subsea 2-phase gas-liquid separator
Subsea 2-phase oil-water separator
Subsea 3-phase gas-oil-water separator
Two stage subsea 3-phase gas-oil-water separator
Valves for multiphase fluids (inlet stream from well(s)
Valve for gas streams
Valve for liquid stream
Valve for water stream
Valve for oil stream
Gas boosting means, such as:
   i. Gas compressors
   ii. Dense gas pumps
Liquid boosting means, such as:
   i. Liquid pump,
   ii. Water and oil pump
   iii. Water pump
   iv. Oil pump
Water boosting means such as
   i. Water pumps
Oil boosting means such as
   i. Oil pumps
Heat exchanger
Pipings, couplings and fittings between modules for fluid transportation.

### Further on the Modules

The liquid stream outlet of the subsea 2-phase gas-liquid separator 102 can be fed into the input of a subsea 2-phase oil-water separator 402, thereby providing a two stage 3-phase separator 403—separating inlet stream from wells into gas, oil and water. The two stage 3 phase separator 403 may form one of a plurality of separation station 720, 721, 722 modules in a larger scalable separation system 700.

Several subsea 3-phase gas-oil-water separators 302 can be combined in a larger scalable separation system 600 including several separation stations 620, 621, 622.

One or more two stage 3 phase separator 403 may be combined with one or more subsea 3-phase gas-oil-water separators 302 to provide a larger scalable separation system.

Larger scalable separation systems 500, 600, 700 can be provided with one or more gas reinjection modules 630. The gas reinjection module 630 include means 540 to receive several gas streams 105. The means 540 may be an inlet manifold with pipe couplings to receive several gas pipes.

Larger scalable separation systems 500 can be provided with one or more liquid pumping modules 531. The liquid pumping module 531 include means 541 to receive several liquid streams 106. The means 541 may be an inlet manifold with pipe couplings to receive several liquid stream pipes.

Larger scalable separation systems 600, 700 can be provided with one or more water reinjecting modules 631. The water reinjecting module 631 can include means 641 to receive several water streams 306. The means 641 may be an inlet manifold with pipe couplings to receive several water streams pipes.

Larger scalable separation systems 600, 700 can be provided with one or more oil pumping modules 632. The oil pumping module 632 can include means 642 to receive several oil streams 308. The means 642 may be an inlet manifold with pipe couplings to receive several water streams pipes.

The embodiments of the present invention provide gas boosting means to provide gas to reinjection wells, thereby providing solutions for CO₂ subsea deposit.

A basic separator system according to the present invention may include one subsea 2-phase gas-liquid separator 102, where the subsea 2-phase gas-liquid separator 102 is provided with an inlet for an inlet stream from one or more wells and a first gas stream outlet and a liquid stream outlet.

Gas stream 105 from the gas stream outlet is directed to a gas boosting means 101, 201 and from the gas boosting means 101, 201 to a reinjection well for deposit of the gas.

The liquid stream 106 is directed from the liquid stream outlet to liquid receiving facilities, optionally with boosting means 103, 303, 304. The liquid receiving facilities can among others be topside platforms, seafloor reservoir or FPSO. The liquid will include oil and other liquids such as water.

The basic system will also include tubings for conveying fluids as well as valves.

A subsea processing system may be composed of: (a) a separator deployed on a mudline, which receives production fluids from wells and separates bulk fluid into single-phase components (gas-liquid for a 2-phase separator or gas-oil-water for a 3-phase separator); (b) a gas boosting equipment for allowing gas reinjection; (c) an oil boosting equipment for enabling the oil to reach the platform/FPSO; (d) a water boosting equipment for allowing water reinjection; and (e) heat exchangers for regulating fluid temperature as necessary.

### PARTICULAR EMBODIMENTS

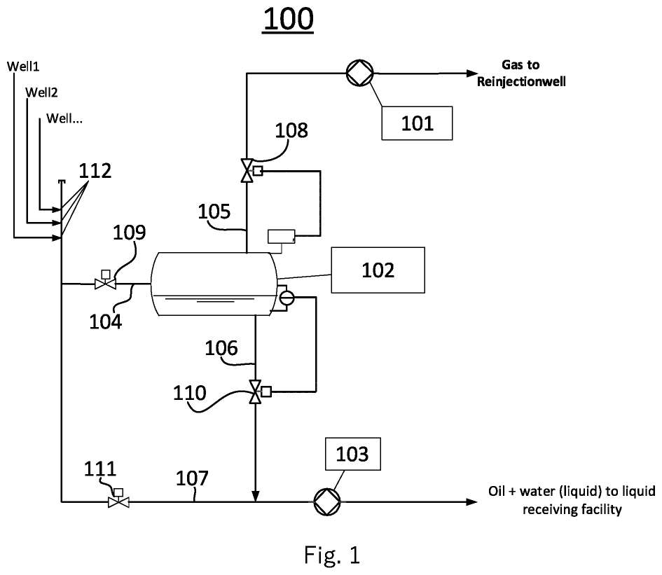

Subsea gas-liquid separation may be performed by using a gravitational separator (see FIG. 1), which gathers the production from a single well or a plurality of wells. The gas-liquid separator separates the bulk flow from the well(s) in a gas stream and a liquid stream (which is composed of oil and water). The liquid is transported to the topside facilities by means of flowlines and risers; in case the liquid is not able to reach topside (due to gravitational and frictional pressure losses), a liquid pump may be necessary for providing the liquid the necessary energy (in the form of a pressure differential) for keeping it flowing. The separated gas may be either reinjected or boosted to topside facilities. The boosting equipment in FIG. 1 is a gas compressor.

Separation pressure, separation temperature, hydrocarbon composition and residence time dictate the volume of gas that vaporises for a given operating condition. Note that, besides hydrocarbons, petroleum may also contain other volatile components, such as CO₂, H₂S, N₂, among others. For elevated separation pressure and temperature, the resulting gas may reach the supercritical state. When this occurs, the supercritical fluid behaves like a gas (filling all container volume), however the fluid possesses a density comparable to the one of a liquid. As mentioned before, since the gas is a mixture of hydrocarbons and other substances, note that not all components may reach the supercritical state, since the critical temperature and pressure is an individual property of each component.

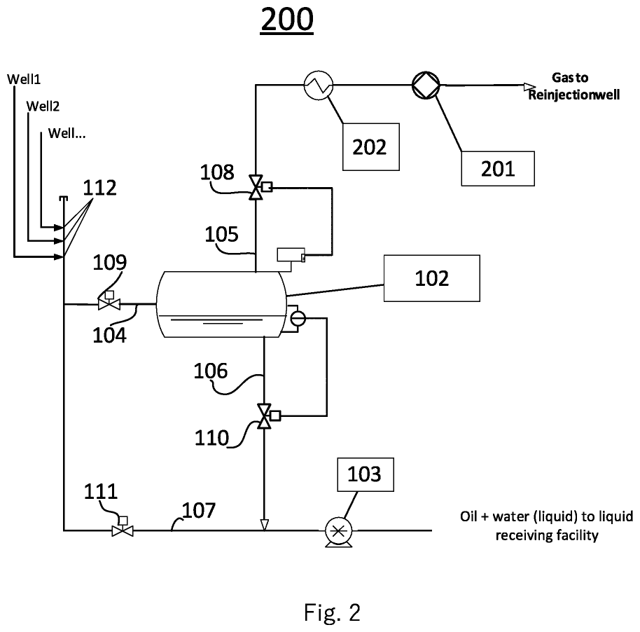

Nonetheless, for gases mixtures with elevated CO₂ content, we may observe the supercritical behaviour as temperatures are higher than about 31° C. and pressures are higher than about 74 bar. In these conditions, the gas stream may be boosted by using a dense gas pump, instead of a compressor (see FIG. 2). To regulate the gas density accordingly, a heat exchanger (cooler) may be utilised. For the pump to work, generally, the higher the gas density the better.

Different pump technologies may be utilised for boosting the separated gas. Some options are: (a) Conventional centrifugal pump, (b) Gas filled motor, or (c) Modular compact pump. The pump could be driven by an induction electric motor or a permanent magnet motor. Different number and configurations of stages, seals, bearings, VFDs (variable frequency driver), intercooling, rotation speed, fluid barrier and couplings may be utilised. The pumps may be combined in series or parallel, depending on the pumped flow rates, required pressure differential, fluid properties, among other operational parameters.

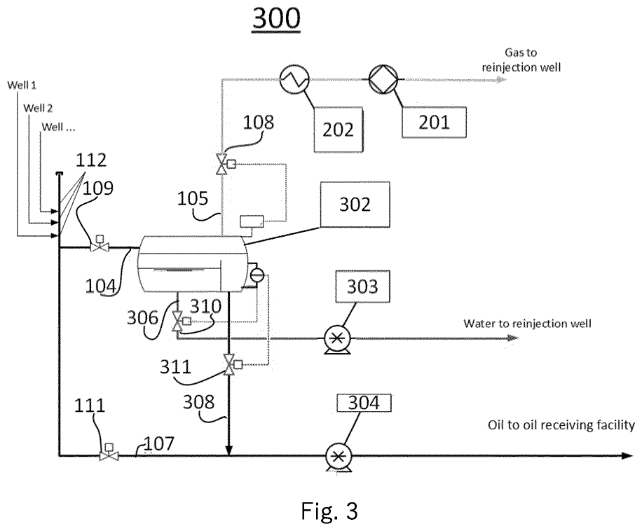

Alternatively, we may consider a separation and reinjection system that makes use of a three-phase gas-oil-water separator (see FIG. 3). Although three-phase separation may be regarded as a more complex process, the advantage gained would be the possibility of sending topside only the separated oil phase. This solution would demand an oil pump, flowlines and risers of diminished size, as well as smaller topside processing equipment, that may result in CAPEX savings. In this case, separated water phase could be either reinjected or be disposed in the ocean after finer filtration.

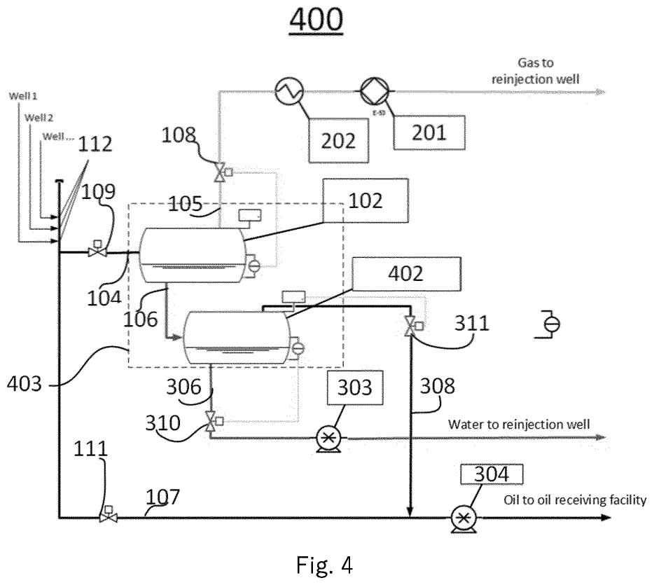

Alternatively, we may consider a separation and reinjection system that makes use of a serial combination of a pair of two-phase separators, being the first a gas-liquid separator, followed by a liquid-liquid separator (see FIG. 4). The first separator would be responsible for separating the gas phase from the liquid phase (oil plus water). Then, the second separator in the sequence would be responsible for separating the oil phase from the water phase. The advantage of this system is that, generally, two-phase separation is operationally simpler to be performed than three-phase separation. Moreover, two-phase separation results in higher separation efficiencies than three-phase separation.

Generally, vessels for installation of subsea equipment has major weight and footprint restrictions. Thus, deploying an entire separation and reinjection module mounted in a single skid (as shown in FIG. 1, FIG. 2, FIG. 3 and FIG. 4) imposes severe limits to the system's processing capacities.

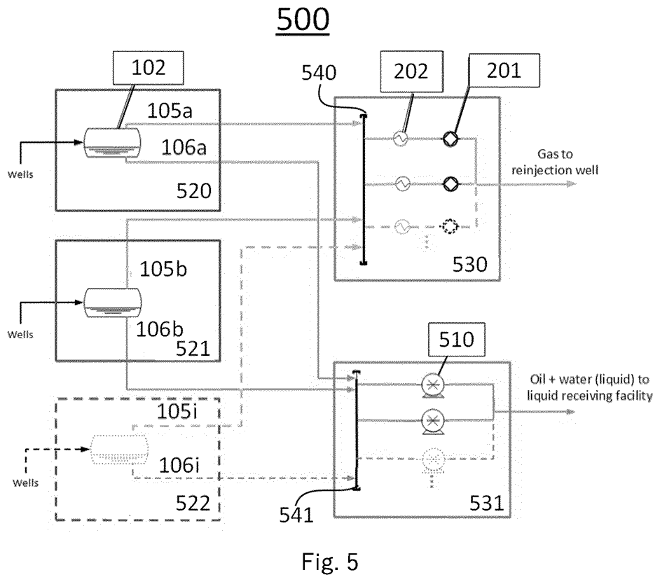

In order to obtain a higher capacity and more flexible processing system, a modularised solution for the entire production field is proposed in FIG. 5. For this solution, observe that the same general process is performed: fluid separation in gravitational separators, gas temperature regulation by means of heat exchangers (coolers) and gas boosting by using a dense gas pump. The difference here is the use of several dedicated separation modules, gas reinjection modules and liquid pumping modules. The gas reinjection module contains the heat exchangers and dense gas pumps, which may be added or retrieved (removed for repair or substitution) as necessary due to variations in gas production. The liquid pumping module contains the liquid pumps, which may also be added or retrieved (removed for repair or substitution), as liquid production varies along field life. Note that, components (dense gas pumps, liquid pumps, and heat exchangers) in each module may vary in number and capacity. Note also that the distance among the several modules may also vary depending on specific production field characteristics.

By deploying the modules separately, as proposed, some advantages are gained: (a) deployment when needed (the cash flow profile along the project life is enhanced); (b) separators of higher capacity may be deployed, being possible the processing of an increased number of wells in a single separator; (c) different number and capacity of pumps may be deployed in the boosting modules (gas reinjection module and liquid pumping module), thus enhancing system availability, providing equipment backup in case of failures and allowing for adaptations on boosting necessities over years as field production varies. Finally, this modularisation will lead to an optimised use of equipment and distributed cash flow that will increase the economic feasibility of a given offshore deep-water field development.

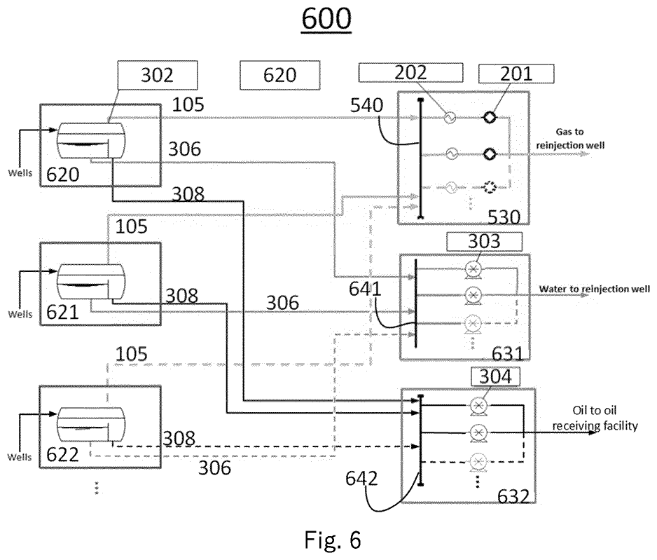

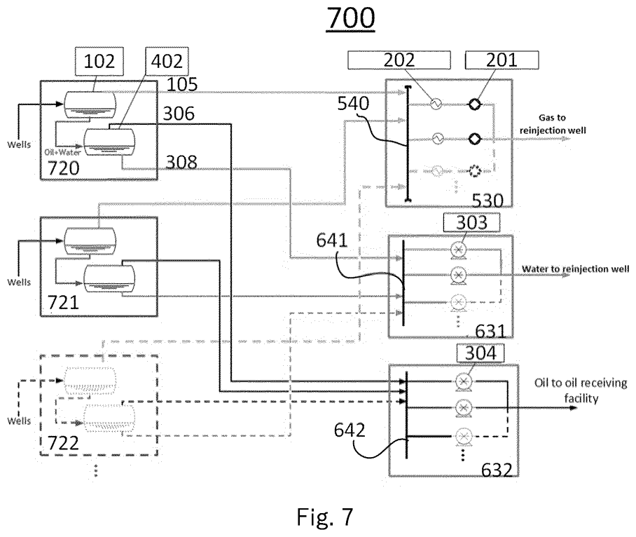

The modularisation can also be applied for the other separation options. FIG. 6 presents a similar field layout, now using a three-phase separator. Likewise, FIG. 7 presents the same field layout, with the difference that a pair of two-phase separators in sequence is utilised for promoting three-phase separation.

Note that a HIPPS (high-integrity pressure protection system) may be installed upstream of the separator vessel (at separator inlet) for preventing over-pressurisation of the vessel. In case of abnormal pressure peaks, the HIPPS will shut-off the high-pressure source before the design pressure of the system is exceeded, thus preventing burst of the vessel. The use of HIPPS allows for reducing the required thickness, (and consequently the weight) of the separation vessel by reducing the maximum pressure that needs to be considered for design purposes.

Observe that, in the figures and diagrams presented, not all auxiliary lines are presented, such as chemical injection lines, by-pass lines, recirculation/recycle loops, control lines, etc. These lines must be designed in a case-by-case procedure, since different equipment requires different service and auxiliary lines.

The separation pressure is an important variable that must be carefully selected, since it affects positively and negatively different parameters. For instance, by diminishing the separator pressure, the following consequences are observed: (a) Enhancing of wells productivity (due to lower back-pressure to the fluids flow), (b) Decreasing of separated gas density, (c) Enhancing of gas vaporisation (higher volumes of gas are separated), (d) Increasing of vessel's material thickness in order to withstand increasingly mechanical stresses, and (e) Increasing of dense gas pump complexity (since a higher pressure-differential is required for gas reinjection; moreover, gas to be pumped is lighter).

Another parameter impacted by the separator pressure is the necessity of a liquid pump for allowing the liquid to reach topside (for cases presented in FIG. 2 and FIG. 5, where oil plus water are transported to topside). As water production increases, higher hydrostatic pressure drop in the riser column is observed, being the use of a liquid pump increasingly necessary. Thus, the higher the separation pressure, the later in the production timeline a liquid pump will be required. Generally, a design guideline for subsea processing systems is simplicity, in the sense that, the number of parts to be deployed subsea must be reduced to a minimum. This design guideline would then point to a higher separation pressure for delaying the necessity of a liquid pump. On the other hand, another design guideline is maximising oil production. For allowing more oil to be produced, a lower separation pressure should be considered. Conventionally, the separator pressure is selected and kept constant for a given system. We propose a compromise solution, in which the separation pressure is varied over years of production: initially a low pressure is assumed, promoting enhanced liquid production and, as water cut increases, separator pressure is proportionally increased for allowing the liquid to reach topside without the need of liquid pumps. This solution allows maximising oil production, while minimising parts installed subsea.

### FURTHER ON THE FIGURES

FIG. 1 shows a basic concept according to the present invention. The FIG. 1 contend a diagram where fluid production come from the wells (is not included but would be come from a manifold) passing through a choke valve 109, 104 arriving inside the subsea gravitational separator vessel 102. Inside the subsea gravitational separator vessel 102 the oil plus produced water going through pipe 106 passing through the valve 110 arriving the pipe 107 and then passing through in liquid pump 103 where this one sending the oil and produced water mixing to the top side. The other way the CO₂ gas goes to line 105 passing through valve 108 and the booster pump 101 to compress the CO₂ gas providing the gas reinjection in the wells.

FIG. 2. shows one aspect of the invention showed in the FIG. 1, but in this case it is added a heat exchanger 202, before the booster pump 202. The objective of this heat exchange is to avoid any flowline blockage like hydrate formation of paraffin, in general caused by the combination of low temperature and high pressure.

FIG. 3. shows another aspect of the invention where key features known from FIG. 2 is present, but in this case it is added one more phase separation in the subsea gravitational separator vessel 102. The oil is separated from the produced water. The oil is sent to an oil receiving facility through a liquid pump 304 and the produced water is reinjected in the well aided by another added liquid pump 303.

FIG. 4 shows a system with the same functionality as that in FIG. 3. However, this diagram presents the initiation of system modularization. A second stage of liquid separation is divided in two vessels, the first vessel stage 102 separate the CO₂ gas from the oil plus water and the second vessel stage 402 separate the oil from the produced water.

FIG. 5. Shows a scaled up version of the system showed in FIG. 2 but in this case the concept has been modularised in aim to promise the field layout versatility. The separation stage, separate the CO₂ gas from the oil plus water, was designed as the module 520 and would be expanded adding more modules as the example of 521, 522, . . . . The heat exchange 202 and the booster pump 201 was designed in the module 530. The liquid pumps 510 design in the module 531.

FIG. 6. Shows a scaled up version of the system showed in FIG. 3 but in this case the concept was modularized with the same objective, provide field versatility. The modularization is the same of FIG. 5, the separation stage, separate the CO₂ gas from the oil plus water, was designed as the module 520 and would be expanded adding more modules as the example of 521, 522, . . . . However, in this case there are three injection modules. The heat exchange 202 and the booster pump 201 was designed in the module 530. The liquid pump to reinject the produced water is a different module 631. The oil is sent to the top side through the liquid pumps in the module 632.

FIG. 7 Show a scaled up version of the system showed in FIG. 4, and in this case is also the versatility implementation through the modularization design applied. All stages of separation are designed in the module 720, where there are two vessels. If the production volume demands more separation volume process more modules would be added for example 721, 722, . . . .

### REFERENCES

| | |
|---|---|
| 100 | Single separation and injection module with compressor |
| 101 | Gas compressor, booster pump |
| 102 | Subsea 2-phase gas - liquid separator |
| 103 | Liquid pump |
| 104 | Separator inlet stream |
| 105 | Gas stream |
| 106 | Liquid stream, i.e. oil + water |
| 107 | By-pass line |
| 108 | First valve, gas stream |
| 109 | Second valve separator inlet stream |
| 110 | Third valve liquid stream |
| 111 | Fourth valve by-pass line |
| 112 | Inlet manifold from wells |
| 200 | Gas - liquid single separation and injection module with |
| | dense gas pump |
| 201 | Dense gas pump |
| 202 | Heat exchanger (cooler) |
| 300 | Gas-oil-water separator single separation with dense |
| | gas pump |
| 302 | Subsea 3-phase gas-oil-water separator |
| 303 | Water pump |
| 304 | Oil pump |
| 306 | Water stream |
| 308 | Oil Stream |
| 310 | Fifth valve, water stream |
| 311 | Sixth valve, oil stream |
| 400 | Gas-liquid separation and Oil -water separation with |
| | dense gas pump |
| 402 | Subsea 2-phase oil - water separator |
| 403 | Two stage gas - oil - water separation station |
| 500 | Multiple separation modules in gas liquid separator |
| 510 | Liquid pump |
| 520 | Separation module 1 |
| 521 | Separation module 2 |
| 522 | Separation module i |
| 530 | Gas reinjection module |
| 531 | Liquid pumping module |
| 540 | Gas reinjection module inlet |
| 541 | Liquid pumping module inlet |
| 600 | Multiple separation modules in gas - oil - water |
| | separator |
| 620 | Separation station 1 |
| 621 | Separation station 2 |
| 622 | Separation station 2 |
| 631 | Water reinjection module |
| 632 | Oil pumping module |
| 641 | Water pumping module inlet |
| 642 | Oil pumping module inlet |
| 700 | Multiple two stage separation modules in gas - oil - |
| | water separator |
| 720 | Separation station A |
| 721 | Separation station B |
| 722 | Separation station n in a n-number separation station |
| | system |

### Abbreviations

| | |
|---|---|
| HIPPS | High-Integrity Pressure Protection System |
| FPSO | Floating, Production, Storage and Offloading vessel |

1. A scalable modular fluid separation system at least comprising:
a) a subsea separator with an inlet for receiving well fluids from a separator inlet stream;
b) a gas stream piping from a gas stream outlet of the subsea separator;
c) a booster pump in communication with the gas stream outlet of the subsea separator;
d) a liquid stream piping from a liquid stream outlet of the subsea separator;
e) a liquid pressure booster in communication with the liquid stream outlet of the subsea separator;
wherein the gas stream is directed from the subsea separator to the booster pump where the gas stream pressure is boosted by the booster pump and directed to a reinjection well, and the liquid stream is directed from the subsea separator to the liquid pressure booster where the liquid stream pressure is boosted by the liquid pressure booster and the liquid is directed to one of a liquid receiving facility, an oil receiving facility and a reinjection well.

2. The scalable modular fluid separation system according to claim 1, further comprising a heat exchanger in communication with the gas stream piping from the subsea separator wherein the gas stream is directed from the subsea separator where the gas stream pressure is boosted by the booster pump and directed to a reinjection well.

3. The scalable modular fluid separation system according to claim 1, where the booster pump is a dense gas pump.

4. The scalable modular fluid separation system according to claim 1, further comprising an inlet manifold, where the inlet manifold is in communication with the inlet for receiving well fluids from a separator inlet stream.

5. The scalable modular fluid separation system according to claim 1, wherein the subsea separator is a subsea 2-phase gas to liquid separator.

6. The scalable modular fluid separation system according to claim 1, wherein the subsea separator is a subsea 3-phase gas-oil-water separator and the 3-phase gas-oil-water separator further includes a water stream outlet and an oil stream outlet.

7. The scalable modular fluid separation system according to claim 6, wherein the water stream is directed from the subsea 3-phase gas-oil-water separator to a water pump where the water stream is boosted by the water pump and the water is directed to a reinjection well, and the oil stream is directed from the subsea 3-phase gas-oil-water separator to an oil pump where the oil stream is boosted by the oil pump and the oil is directed to an oil receiving facility.

8. The scalable modular fluid separation system according to claim 5, wherein the liquid stream is directed from the liquid stream outlet of the subsea 2-phase gas-liquid separator to an inlet of a 2-phase oil water separator to provide a two stage gas-oil-water separation station where the liquid is separated into:
a. a water stream and where the water stream is directed to a water pump where the water stream is boosted by the water pump and the water is directed to a reinjection well, and
b. an oil stream and where the oil stream is directed to an oil pump where the oil stream is boosted by the oil pump and the oil is directed to an oil receiving facility.

9. The scalable modular fluid separation system according to claim 1, where the scalable modular fluid separation system further comprises:
a. several 2-phase subsea separators each with an inlet for receiving well fluids from an associated well;
b. a gas stream piping from a gas stream outlet of each of the 2-phase subsea separators;
c. a gas reinjection module in communication with the gas stream outlet of the several 2-phase subsea separators;
d. a liquid stream piping from a liquid stream outlet of each of the 2-phase subsea separator;
e. a liquid pumping module in communication with the liquid stream outlet of the several 2-phase subsea separators;
wherein the gas streams are directed from each of the 2-phase subsea separators to a gas reinjection module inlet where each of the gas streams are directed to a booster pump and directed to a reinjection well, and each of the liquid streams are directed from each of the 2-phase subsea separators to a liquid pumping module inlet where each of the liquid streams are directed to a liquid pressure booster and the liquid is directed to one of a liquid receiving facility, an oil receiving facility and a reinjection well.

10. The scalable modular fluid separation system according to claim 9, where the gas reinjection module inlet is an inlet manifold, and where the liquid pumping module inlet is an inlet manifold.

11. The scalable modular fluid separation system according to claim 9, where the gas reinjection module further comprises heat exchangers.

12. The scalable modular fluid separation system according to claim 1, where the scalable modular fluid separation system further comprises:
a. several 3-phase subsea separators each with an inlet for receiving well fluids from an associated well;
b. a gas stream piping from a gas stream outlet of each of the 3-phase subsea separators;
c. a gas reinjection module in communication with the gas stream outlet of the several 3-phase subsea separators;
d. a water stream piping from a water stream outlet of each of the 3-phase subsea separators;
e. a water reinjecting module in communication with the water stream outlet of the several 3-phase subsea separators;
f. an oil stream piping from a water stream outlet of each of the 3-phase subsea separators;
g. an oil pumping module in communication with the oil stream outlet of the several 3-phase subsea separators,
wherein the gas streams are directed from each of the 3-phase subsea separators to a gas reinjection module inlet where each of the gas streams are directed to a booster pump and directed to a reinjection well, and each of the water streams are directed from each of the 3-phase subsea separators to a water pumping module inlet where each of the water streams are directed to a water pressure booster and the water is directed to a reinjection well, and each of the oil streams are directed from each of the 3-phase subsea separators to an oil pumping module inlet where each of the oil streams are directed to an oil pressure booster and the oil is directed to an oil receiving facility.

13. The scalable modular fluid separation system according to claim 12, where the gas reinjection module inlet is an inlet manifold, the water pumping module inlet is an inlet manifold, and where the oil pumping module inlet is an inlet manifold.

14. The scalable modular fluid separation system according to claim 12, where the gas reinjection module further comprises heat exchangers.

15. The scalable modular fluid separation system according to claim 8, where the scalable modular fluid separation system further comprises:
a. several two stage gas-oil-water separation stations each with an inlet for receiving well fluids from an associated well;
b. a gas stream piping from a gas stream outlet of each of the two stage gas-oil-water separation;
c. a gas reinjection module in communication with the gas stream outlet of the several two stage gas-oil-water separation stations;
d. a water stream piping from a water stream outlet of each of the two stage gas-oil-water separation stations;
e. a water reinjecting module in communication with the water stream outlet of the several two stage gas-oil-water separation stations;
f. an oil stream piping from a water stream outlet from each of the two stage gas-oil-water separation stations;
g. an oil pumping module in communication with the oil stream outlet of the several two stage gas-oil-water separation stations,
wherein the gas streams are directed from each of the two stage gas-oil-water separation stations to a gas reinjection module inlet where each of the gas streams are directed to a booster pump and directed to a reinjection well, and each of the water streams are directed from each of the two stage gas-oil-water separation stations to a water pumping module inlet where each of the water streams are directed to a water pressure booster and the water is directed to a reinjection well, and each of the oil streams are directed from each of the two stage gas-oil-water separation stations to an oil pumping module inlet where each of the oil streams are directed to an oil pressure booster and the oil is directed to an oil receiving facility.

16. The scalable modular fluid separation system according to claim 15, where the gas reinjection module inlet is an inlet manifold, the water pumping module inlet is an inlet manifold, and where the oil pumping module inlet is an inlet manifold.

17. The scalable modular fluid separation system according to claim 15, where the gas reinjection module further comprises heat exchangers.
